(19) United States
(12) Patent Application Publication
(10) Pub. No.: US 2007/0011726 A1
(43) Pub. Date: Jan. 11, 2007

(54) Multi-function peripheral with function of adding user identification information and method thereof

(75) Inventor: Jun Choi, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/450,407

(22) Filed: Jun. 12, 2006

(30) Foreign Application Priority Data
Jul. 11, 2005 (KR) 2005-0062235

(51) Int. Cl. H04L 9/32

(52) U.S. Cl. 726/5

(57) ABSTRACT

A multi-function peripheral (MFP) with a function of adding user identification information and a method thereof are provided for increasing security of documents. The MFP comprises a scanning unit for generating image data by scanning a document upon request of scanning, a metadata generator for receiving user identification information regarding a user who has requested scanning and generating metadata, and a controller for adding the metadata to the image data and converting the data into digital data. Accordingly, the user who initially scanned the document may be determined in order to notify a user of the document's security and strengthen responsibility for the scanned data.

### CROSS-REFERENCE TO RELATED APPLICATIONS

This application claims the benefit under 35 U.S.C. § 119(a) of Korean Patent Application No. 2005-62235, filed Jul. 11, 2005 in the Korean Intellectual Property Office, the entire disclosure of which is hereby incorporated by reference.

### BACKGROUND OF THE INVENTION

1. Field of the Invention

The present invention relates to a multi-function peripheral with a function for adding user identification information and a method thereof. More particularly, the present invention relates to a multi-function peripheral with a function for adding user identification information to recognize a user performing scanning by adding the user identification information to scanned data and a method thereof.

2. Description of the Related Art

In general, a multi-function peripheral (MFP) is one device, which functions as a printer printing data transmitted from a host computer, facsimile, scanner and copying machine.

As the MFP is commonly used in an office by a number of users, user authentication is required for information security of corporate or other documents used for diverse functions in the MFP, such as scanning.

By providing a user authentication process in order to use the MFP, each user previously registers user identification (ID) to the MFP or an authentication server connected to the MFP. The user inputs authentication information, such as the user ID and a corresponding password, if user authentication is required. The MFP or authentication server authenticates the user according to the input authentication information.

If the user authentication is used, an unauthenticated user cannot perform an operation of scanning secure documents or the like. As a result, illegal scanning by an unauthenticated user is prevented in order to guarantee security.

However, when a secured generated image data is publicly disclosed or is illegally used by other users after an authenticated user finishes scanning secure documents, liability cannot be determined. Accordingly, measures to prevent careless management of scanned data are required.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a multi-function peripheral with a function of adding user identification information to scanned data in order to recognize a user who performs scanning and a method thereof.

In order to achieve the above-described aspects of exemplary embodiments of the present invention, there is provided a multi-function peripheral (MFP), in which a scanning unit generates image data by scanning a document upon request of scanning, a metadata generator receives user identification information regarding a user who has requested scanning and generating metadata, and a controller adds the metadata to the image data and converts the data into digital data.

In an exemplary implementation, the controller may authenticate the user upon request of scanning and provide a user ID included in an input user authentication information as the user identification information to the metadata generator.

In a further exemplary implementation, the user identification information may comprise at least one of the user ID, a name and position.

In another exemplary implementation, the controller may authenticate the user by communicating with an authentication server having authentication information regarding the user through the network.

In still another exemplary implementation, a storage previously stores the user identification information, and the controller searches for the user identification information and provides the information to the metadata generator.

In an exemplary implementation, the controller may authenticate the user upon request of scanning by searching the storage for the user ID included in the input user authentication information.

In a further exemplary implementation, the controller combines the metadata and the image data to convert into a single digital data file.

In an exemplary implementation, the controller may convert the metadata into the digital data separated from the image data.

In another exemplary implementation, the controller may attach the metadata converted into the digital data to the image data in order to transmit the data upon request of transmitting the document.

A method of adding user identification information of an MFP according to an exemplary embodiment of the present invention comprises image data generated by scanning a document upon request of scanning, user identification information generated regarding a user who requested the scanning as metadata, and the metadata added to the image data and converting the data into digital data.

In an exemplary implementation, the user identification is authenticated upon request of scanning and a user ID included in an input user authentication information is provided as the user identification information to the metadata generated.

In a further exemplary implementation, the user identification information provided may authenticate the user by communicating with an authentication server having the user authentication information through the network.

In another exemplary implementation, the user identification information may comprise at least one of the user ID, a name and position.

In still another exemplary implementation, the user identification information is previously stored, the user is authenticated upon request of scanning, the user identification information is searched according to the user ID included in the input user authentication information and the user identification information is provided to the metadata generated.

In an exemplary implementation, the data converted into digital data may combine the metadata and the image data to convert into a single digital data file.

In a further exemplary implementation, the image data added with the metadata converted into the digital data file is transmitted to a destination of transmission upon request of transmitting the document.

In another exemplary implementation, the transmission may be performed according to at least one of email, file transfer protocol (FTP), Universal Serial Bus (USB), Infrared Data Association (IrDA), Bluetooth, and Wireless Local Area Network (LAN).

In still another exemplary implementation, the data converted into digital data may convert the metadata into the digital data separated from the image data.

In an exemplary implementation, the metadata converted into the digital data file is converted to the image data in order to transmit the data upon request of transmitting the document.

In another exemplary implementation, the user identification information is previously stored, the user is authenticated upon request of scanning, the user identification information is searched according to the user ID included in the input user authentication information and the user identification information is provided to the metadata generated.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWING FIGURES

The above and other objects, features, and advantages of certain exemplary embodiments of the present invention will be more apparent from the following description taken in conjunction with the accompanying drawings, in which:

FIG. 1 is a view showing an environment where an MFP according to an exemplary embodiment of the present invention is applied;

FIG. 2 is a block diagram showing an MFP according to an exemplary embodiment of the present invention; and

FIG. 3 is a flow chart showing an operation of an MFP according to an exemplary embodiment of the present invention.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

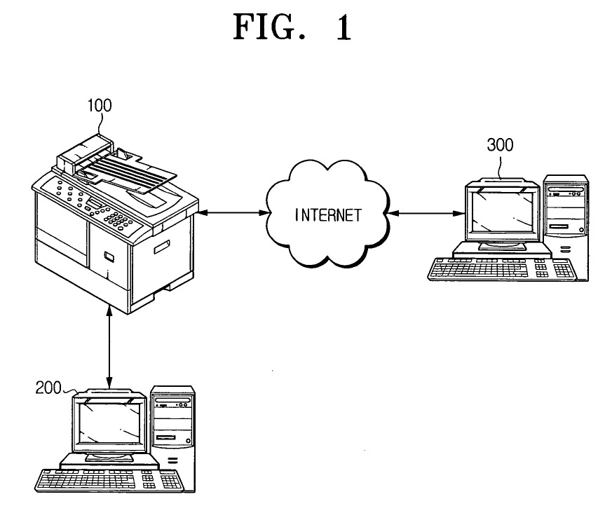

FIG. 1 shows an environment where an MFP with a function of adding user identification information according to an exemplary embodiment of the present invention is applied.

An MFP 100 is connected to a computer 200 to exchange various data such as scanned data or print data. Also, the MFP 100 performs user authentication by storing user authentication information, or by communicating with an authentication server 300 through the Internet or the like.

According to an exemplary embodiment of the present invention, a user previously registers authentication information such as a user ID and a corresponding password to the authentication server connected to the MFP 100. If a function requiring authentication is selected, the user inputs authentication information to the MFP 100. The MFP 100 performs user authentication by communicating with the authentication server and receiving authentication information, or by transmitting the input authentication information to the authentication server and receiving a result of authentication from the authentication server.

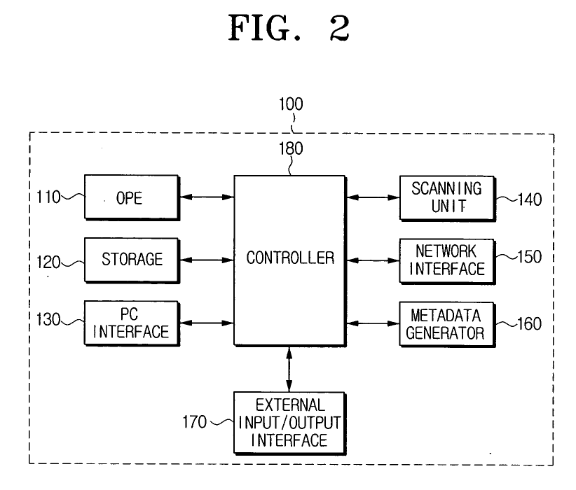

FIG. 2 is a block diagram showing an MFP with a function of adding user identification information according to an exemplary embodiment of the present invention.

Referring to FIG. 2, the MFP 100 comprises an operating panel 110, storage 120, personal computer (PC) interface 130, scanning unit 140, network interface 150, metadata generator 160, external input/output interface 170 and controller 180.

Detailed description will be limited to the MFP 100 components necessary to perform a function of adding user identification information according to an exemplary embodiment of the present invention. Detailed description of other components will be omitted for clarity and conciseness.

An operating panel 110 comprises an input unit (not shown) for having plural function keys and number keys used to set and select functions supported in the MFP 100 and for supplying a key input signal to the controller 180 according to a key operation. The operating panel 110 also comprises a display unit (not shown), generally in the form of a liquid crystal display (LCD), for displaying an operation state and various information according to control of controller 180. When a function requiring user authentication is selected through the input unit, the display unit, according to an exemplary embodiment of the present invention, displays a dialog box, or the like, to allow user authentication information to be entered.

The storage 120 comprises a read only memory (ROM, not shown) of a nonvolatile memory element and a random access memory (RAM, not shown) of a volatile memory element. The ROM stores various control programs required to implement various functions supported in the MFP 100; firmware combining the data scanned by the scanning unit 140 and the metadata generated by the metadata generator 160; and converting the combined data into digital data, authentication information to authenticate a user, an authentication program, and a data transmission protocol. The RAM stores various data generated during operation of the MFP 100. The RAM temporarily stores the data scanned by the scanning unit 140 or the like.

The PC interface 130 is connected to the host computer 200, which is an external device and supports communication interface with the host computer 200. The PC interface 130 receives print data transmitted from the host computer or transmits the data scanned by the scanning unit 140 to the host computer 200.

The scanning unit 140 generates image data by scanning documents according to the control of the controller 180. After the image data generated by the scanning unit 140 are converted into digital data by the controller 180, the data are temporarily stored in the RAM, combined with the user identification information output from the metadata generator 160 and stored in the ROM; or transmitted to the external device through the PC interface 130, network interface 150, or external input/output interface 170.

The network interface 150 provides a fax transmission function to transmit and receive fax data, and an email transmission function to transmit and receive email. The network interface 150 is equipped in the MFP 100 to communicate with external devices on the network and with the authentication server 300. The network interface 150 can also be integrated into a board of the MFP 100 for convenience of network construction.

Accordingly, the controller 180 can email data through the network interface 150 or transmit data to other devices on the network according to a protocol such as the file transfer protocol (FTP).

The metadata generator 160 sorts user identification information for identification of user authentication information input for authentication. The metadata generator 160 then converts the information into metadata according to a data format of the scanned data, and provides the metadata to the controller 180. Concurrently, a name, position, and other information of a user corresponding to the user ID of the user authentication information are input as user identification information upon registering a user and stored in the storage 120. If a scan command is input and user authentication is performed, the controller 180 searches for the user identification information using the user ID and provides the data to the metadata generator 160.

Metadata are data added to main data for data attribute or for convenience of retrieval. The metadata comprises, but is not limited to, a storage location and contents of the main data, user information, rights condition, usage condition, and usage history according to a certain rule to efficiently search the corresponding information. One example of metadata applied to image data is an exchangeable image file (EXIF).

The metadata generator 160 according to an exemplary embodiment of the present invention generates user identification information including the input information such as a user ID, name, position, and ID of the MFP 100 upon authenticating a user in metadata of a certain format, such as, the EXIF format. The external input/output interface 170 can be connected to an external input/output device (not shown) such as a memory card so that the external input/output interface 170 receives data from the external input/output device, provides the data to the controller 180, and outputs the data from the controller 180 to the external input/output device. The external input/output interface 170 supports interfaces, such as the Universal Serial Bus (USB) method of a wired communication method, Infrared Data Association (IrDA) method of a wireless communication method, Bluetooth method, Wireless Local Area Network (LAN), and the like. Accordingly, the controller 180 can transmit the scanned data to a wide rage of external input/output devices, for example, to a memory card with a communication port of the USB method through the external input/output interface 170.

If a performance command such as a scan command is input through the operating panel 110, the controller 180 entirely controls the MFP 100 according to the control program stored in the storage 120.

According to an exemplary embodiment of the present invention, if a scan command is input, the controller 180 displays information through the display unit of the operating panel 110 in order for a user to input user authentication information. If the user authentication information is input, the controller 180 performs authentication according to the authentication program stored in the storage 120 or performs authentication by communicating with the authentication server 300 through the network interface 150.

Additionally, if the user authentication is successfully completed, the controller 180 controls the scanning unit 140 to perform scanning, and the generated image data are temporarily stored in the RAM of the storage 120. Concurrently, the controller 180 provides user identification information to the metadata generator 160, and the metadata generator 160 generates the user identification information in metadata of a certain format.

Accordingly, the controller 180 combines metadata and image data using the firmware stored in the storage 120, and converts the combined data into digital data. On the other hand, the controller 180 can convert the image data into digital data, convert the metadata into a digital data file separated from the image data, and store the digital data and the digital data file together in the storage 120. In this instance, the controller 180 attaches the metadata to the image data upon request of transmission of the image data and transmits the data to a destination of transmission.

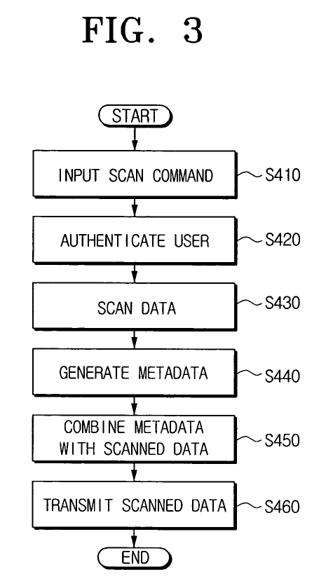

FIG. 3 is a flow chart showing an operation of adding user identification information as metadata to scanned data of an MFP according to an exemplary embodiment of the present invention.

If a user inputs a scan command for a certain document through the input unit of the operating panel 110 (S410), the controller 180 notify the user to input user authentication information through the operating panel 110, and authenticates the user by using the user authentication program stored in the storage 120 or communicating with the authentication server 300 based on the input user authentication information (S420).

If the user authentication is successfully completed, by confirming that the user is a registered user, the controller 180 controls the scanning unit 140 to scan the corresponding document (S430) and generated image data are temporarily stored in the RAM of the storage 120.

In addition, the controller 180 provides user identification information including a user ID in user authentication information to the metadata generator 160 and generates metadata of a certain format (S440).

When the metadata are generated, the controller 180 combines the metadata with the image data and converts the combined data into digital data, or converts the metadata into digital data separated from the image data, and stores the converted data in the storage 120 (S450).

The scanned data are printed as print data, transmitted to the host computer 200 on request of transmission, emailed to the destination, transmitted to other devices on the network according to a protocol such as the file transfer protocol (FTP), or transmitted to an external input/output device through an interface method, such as the USB, IrDA, Bluetooth and WLAN (S460). When transmitting the image data, if the controller 180 converts the metadata into digital data separated from the image data, the controller 180 attaches the metadata to the image data and transmits the data to the destination of transmission.

As user identification information is added to the scanned data converted into digital data as metadata, and once the scanned data of the document are found in a certain device, the person who initially scanned and generated the document may be determined. Accordingly, the scanned data and scanning operation may be carefully managed by the users due to enhanced accountability. As the result, documents that require security may remain secure.

As can be appreciated from the above description, the person who initially scanned a document and publicly discloses the data may be determined by adding identification information of the user who scanned the document as the metadata to the data. Accordingly, a user is notified of the security of documents and responsibility for the scanned data is strengthened. As the result, the security of documents can increase.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A multi-function peripheral (MFP), comprising:
a scanning unit for generating an image data by scanning a document upon request of scanning;
a metadata generator for receiving user identification information once scanning is requested and generating metadata; and
a controller for adding the metadata to the image data and converting at least one of the image data and the metadata into digital data.

2. The MFP of claim 1, wherein the controller authenticates the user identification information upon request of scanning and provides a user ID in an input user authentication information as the user identification information to the metadata generator.

3. The MFP of claim 2, wherein the controller authenticates the user identification information by communicating with an authentication server comprising the user authentication information through the network.

4. The MFP of claim 1, wherein the user identification information comprises at least one of the user ID, a name and employment position or title.

5. The MFP of claim 1, further comprising a storage for previously storing the user identification information, and
wherein the controller searches for the user identification information and provides the information to the metadata generator.

6. The MFP of claim 5, wherein the controller authenticates the user identification information upon request of scanning by searching the storage for the user ID in the input user authentication information.

7. The MFP of claim 1, wherein the controller combines the metadata and the image data to convert into a single digital data file.

8. The MFP of claim 1, wherein the controller converts the metadata into the digital data separated from the image data.

9. The MFP of claim 8, wherein the controller attaches the metadata converted into the digital data to the image data, in order to transmit the data upon request of transmitting the document.

10. A method of adding user identification information of an MFP, comprising:
generating an image data by scanning a document upon request of scanning;
generating user identification information as metadata once the scanning is requested; and
adding the metadata to the image data and converting at least one of the image data and the metadata into digital data.

11. The method of claim 10, further comprising authenticating the user identification information upon request of scanning and providing a user ID in an input user authentication information as the user identification information to the generating of the metadata.

12. The method of claim 11, wherein providing the user identification information authenticates the user identification information by communicating with an authentication server comprising the user authentication information through the network.

13. The method of claim 10, wherein the user identification information comprises at least one of the user ID, a name and employment position or title.

14. The method of claim 10, further comprising previously storing the user identification information, authenticating the user identification information upon request of scanning, searching for the user identification information according to the user ID in the input user authentication information, and providing the user identification information to the generating of the metadata.

15. The method of claim 10, wherein the converting of the data into digital data comprises combining the metadata and the image data to convert into a single digital data file.

16. The method of claim 10, further comprising transmitting the digital data to a destination of transmission upon request of transmitting the document.

17. The method of claim 16, wherein the transmission is performed according to at least one of email, file transfer protocol (FTP), Universal Serial Bus (USB), Infrared Data Association (IrDA), Bluetooth, and Wireless Local Area Network (LAN).

18. The method of claim 10, wherein the converting of metadata and image data into digital data comprises converting the metadata into the digital data separated from the image data.

19. The method of claim 18, further comprising attaching the metadata converted into the digital data to the image data, in order to transmit upon request of transmitting the document.

20. The MFP of claim 1, wherein the metadata comprises a storage location and at least one of contents of the meta data, user information, rights condition, usage condition, and usage history according to a certain rule to efficiently search corresponding information.

21. The method of claim 10, wherein the metadata comprises a storage location and at least one of contents of the meta data, user information, rights condition, usage condition, and usage history according to a certain rule to efficiently search corresponding information.
